(19) United States
(12) Patent Application Publication
(10) Pub. No.: US 2006/0080250 A1
(43) Pub. Date: Apr. 13, 2006

(54) System and method for providing a hedge fund structured products platform

(76) Inventors: Matthew Hansen, New York, NY (US); Cornelia Spiegel, New York, NY (US); Dmitry Noraev, New Providence, NJ (US)

Correspondence Address: MORGAN LEWIS & BOCKIUS LLP, 1111 PENNSYLVANIA AVENUE NW, WASHINGTON, DC, 20004, US

(21) Appl. No.: 11/187,168

(22) Filed: Jul. 21, 2005

Related U.S. Application Data
(60) Provisional application No. 60/590,291, filed on Jul. 21, 2004.

(51) Int. Cl. G06Q 40/00

(52) U.S. Cl. 705/42

(57) ABSTRACT

In one aspect, the present invention comprises a computer system for providing an infrastructure platform. That computer system preferably comprises a bank computer operable to communicate via a computer network with a fund manager computer operated by a fund manager managing a fund, wherein the bank computer is operated by a bank holding a security interest over one or more assets of the fund. The bank preferably has agreed with the fund manager to a set of one or more investment guidelines regarding the fund. Those guidelines constrain the fund manager to trade the assets in a specified manner. The fund preferably underlies a structured product sold to one or more investors.

### CROSS-REFERENCE TO RELATED APPLICATIONS

This application claims the benefit of U.S. Provisional Application No. 60/590,291, filed Jul. 21, 2004. The entire contents of that provisional application are incorporated herein by reference.

### BACKGROUND & SUMMARY

One aspect of the present invention comprises systems and methods for providing a platform that allows sophisticated investors to invest into a single fund manager's strategy via a structured product. Preferred features comprise an integrated infrastructure platform and risk management technology, proprietary pricing models, and trading methodology.

Structured products on single fund managers provide advantages over direct fund ownership to both investors and fund managers. Investors can benefit from a) customizable structured pay-off and/or principal protection; (b) enhanced returns through non-recourse leverage; (c) tax efficiency (e.g., a Black-Scholes option may provide deferral and re-characterization of gains for taxable investors and/or avoid Unrelated Business Income Tax for tax-exempt investors); and (d) improved regulatory capital treatment. Fund managers benefit from: (a) access to new investor class: investors who require principal protection, leverage or tax efficiency; and (b) non-recourse leverage to investors that translates into a comparatively larger investment amount and enhanced fee revenues.

The invention relates to a platform for creating and managing structured products or derivatives on a fund manager's strategy. For the present invention the underlying asset is a fund manager's strategy embodied in a legal fund entity in the form of a Limited Liability Company or Limited Liability Partnership (referred to herein as the “Fund”).

For the present invention the structured product or derivative preferably is either: (i) a Black-Scholes Option (also called “Option” herein), (ii) a Periodic Reset Option (“PRO”); or (iii) any structured investment whose value is derived from the underlying asset. The provider of the structured product preferably is a financial institution (the “Bank”).

Structured products on single funds are uncommon. Most Funds are unregulated entities. Since fund managers are unrestricted in their investment options they are free to employ a variety of investment strategies to increase profits which could lead to wildly inherent fluctuations in the rate of return of the Fund. Fund managers typically provide only limited transparency into their investment portfolios. The pricing models employed by the structured product provider would typically involve and estimate of the implied volatility of an underlying asset (that is the variability of the assets value over time with respect to its mean or average value). The lack of transparency into Fund portfolios and the variability of the strategy employed makes such volatility estimates difficult.

Moreover, Funds typically provide only limited liquidity for investors to buy into or redeem out of the Fund. The risk management schemes employed by the structured product provider would typically involve a direct investment in the underlying Fund to create a risk neutral position for the Bank between the structured product sold to the investor and the underlying asset held by the Bank. The lack of liquidity of Funds makes such investment and subsequent rebalancing of such investment difficult.

In one aspect, the present invention comprises a computer system for providing an infrastructure platform. That computer system preferably comprises a bank computer operable to communicate via a computer network with a fund manager computer operated by a fund manager managing a fund, wherein the bank computer is operated by a bank holding a security interest over one or more assets of the fund. The bank preferably has agreed with the fund manager to a set of one or more investment guidelines regarding the fund. Those one or more guidelines constrain the fund manager to trade the one or more assets in a specified manner. The fund preferably underlies a structured product sold to one or more investors. In various embodiments: (a) the structured product comprises at least one of: (1) a Black-Scholes option, (2) a periodic reset option, and (3) another structured product; (b) the system further comprises a securities (e.g., structured volatility) trading desk computer in communication with the bank computer and operable to monitor the fund's compliance with the one more investment guidelines and fund's net asset value; (c) the securities trading desk computer is further operable to calculate a realized volatility of the fund's returns on a daily basis; (d) the system is operable to price the structured product based on a historical volatility calculation; (e) the historical volatility calculation is based on a software-implemented simulation model that estimates historical realized volatilities of one or more portfolios based on one or more investment constraints defined in the one or more investment guidelines; (f) the investment constraints relate to at least one of: a long portion and a short portion of one or more portfolios; (g) the securities trading desk computer is further operable to adjust a position in the fund by trading outside the fund in an underlying asset basket; (h) the position is adjusted based on deviation of an option delta; (i) the option comprises at least one of Black-Scholes option; and (j) the securities trading desk computer is further operable to continuously assess a risk position based on fund data received from a prime brokerage account computer.

In another aspect, the invention comprises a computer system for providing an infrastructure platform, wherein the computer system comprises a fund manager computer operated by a fund manager managing a fund; and a bank computer in communication with the fund manager computer via a computer network, wherein the bank computer is operated by a bank holding a security interest over one or more assets of the fund, the bank having agreed with the fund manager to a set of one or more investment guidelines regarding the fund; wherein the one or more investment guidelines constrain the fund manager to trade the one or more assets in a specified manner; and wherein the fund underlies a structured product sold to one or more investors.

The above-described aspects are not intended to limit the scope of the invention or of the claims. Other aspects of the invention will be apparent from the detailed description provided below.

### BRIEF DESCRIPTION OF THE DRAWINGS

FIG. 1 depicts an execution schematic for a preferred embodiment.

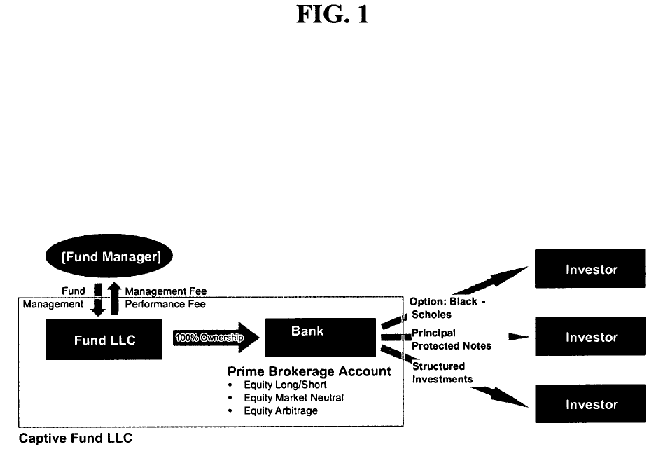

### DETAILED DESCRIPTION OF PREFERRED EMBODIMENTS

### Integrated Infrastructure Platform

A preferred embodiment of the present invention provides an infrastructure platform that seamlessly integrates prime brokerage, risk management, and volatility sales and trading to effectively price and risk manage a structured product suite on a single Fund's returns.

Each fund manager admitted to the platform manages a Fund underlying a structured product sold to the investors in a segregated entity. The entity is set up for the manager on the platform in the legal form of a Limited Liability Company or a Limited Partnership (the “Funds”). The Funds on the platform are prime brokered at a Bank, providing the Bank with security interest over the Fund's assets and an ability to independently price the assets in the Fund. This also provides the Bank with transparency into the Fund's portfolio on a daily basis. For each Fund on the platform the Bank agrees to a set of Investment Guidelines with the fund manager. The Investment Guidelines are designed to allow the fund manager to trade the assets of the Fund in substantially the same manner as his “flagship” fund. They cover the levels of diversification and liquidity of the assets of each Fund and the types of assets to be traded. They also typically contain a maximum allowed level of realized volatility of the Fund's returns over a pre-defined rolling window of a pre-defined number of days. Appendix A describes sample Investment Guidelines.

The Investment Guidelines allow the Bank to estimate an implied volatility of the Fund's returns based on these constraints (see below) and also monitor the fund manager's compliance with these constraints on a daily basis to keep the volatility of the Fund's returns below an initially estimated level. The platform infrastructure provides for seamless connectivity between a prime brokerage account management system and risk management software operable to price and hedge risk in the structured products sold to investors by a securities trading desk, such as a structured volatility trading desk (“Trading Desk”). The Trading Desk monitors the Fund's net asset value (“NAV”) (defined as the total assets of the Fund minus the total liabilities of the Fund) and calculates the realized period volatility of the fund's returns on a daily basis. If any of the Investment Guidelines are breached by the fund manager, the Trading Desk will notify the fund manager of the breach. The fund manager must cure the breach within a pre-defined time, typically two business days; alternatively, the structured product trade with investors will be terminated, leading to the termination of the Fund on the platform.

### Pricing, Simulation Models and Methodology

The difficulty in correctly assessing the price of a structured product typically lies in finding an accurate estimate for the implied volatility of the underlying asset's rate of return over the term of the structured product sold to investors. Implied volatility of the underlying asset's returns is one of the most relevant inputs to most derivative pricing models. Because Fund managers are free to employ a variety of investment strategies to increase profits, the rate of return of the Fund could fluctuate significantly over time and is therefore inherently difficult to estimate correctly. A preferred embodiment of the present invention includes a software-implemented simulation model that estimates historical realized volatilities of various stock portfolios under given investment constraints defined in the Investment Guidelines. This historical volatility calculation is a valuable benchmark for assessing the implied volatility inherent in an investment strategy under predetermined constraints. A system implementing the model preferably comprises a database, C++ code providing simulation, and spreadsheet output.

Simulation portfolios can be long and short and also have a cash component. An exemplary database stores the closing prices of Russel3000 stocks from 1996 to the end of 2004, categorized into 73 different sectors.

The input parameters for the simulator can be broken up into three sets. Parameters used to set up the initial portfolio preferably comprise:

Number of long sectors

Number of short sectors

Number of long stocks, n_{L}

Number of short stocks, n_{S}

Long factor, f_{L}

Short factor, f_{S}

The Investment Guidelines provide the constraints on the portfolio. The portfolio preferably is readjusted to conform to these constraints, as specified by the following parameters:

Lower bound on “Long-Short over Equity” ratio, k_{L}

Upper bound on “Long-Short over Equity” ratio, k_{U}

Max leverage, L

Upper bound of short, c_{S}

Upper bound of long, C_{L}

Overall parameters preferably comprise:

Start date

End date

Number of Simulations

MovingWindow

DaysPerYear

The simulation parameters can be set to designate which sectors will be used in the simulation in the long portfolio, the short portfolio, and both. A sector parameter being long means that its constituents will be sampled for the long portfolio only. A sector parameter being short means that its constituents will be sampled for the short portfolio only.

Each simulation starts with setting up a portfolio. The “Number of long sectors” is randomly chosen to provide long sectors, and the “Number of short sectors” to provide shorts. From these sectors a “Number of long stocks” and a “Number of short stocks” are randomly chosen to be long and short stocks in the portfolio.

Initial value of the portfolio is determined as P=P_{L}−P_{S} +P_{C}, where P_{L}=f_{L} * Notional, P_{S}=f_{S}* Notional, and P_{C}=Notional. P_{L} being the value of the long portion of the portfolio, P_{S} the value of the short portion of the portfolio, P_{C} the value in cash.

The number of long individual stocks at Start date is equal to nᵢ^{L}=P_{L}/(n_{L}Sᵢ), where Sᵢ is the closing price of i-th stock at Start date. A similar relationship is used for short stocks. Under these constraints the simulation goes from Start date to End date. Every day the value P of the portfolio is recorded and verified against the following constraints:
P_{L-}P_{S}<k_{U}P
P_{L-}P_{S}>k_{L}P
P_{L}<LP
P_{S}<LP
nᵢ^{L}Sᵢ<c_{L}P_{L}, for each i=1 . . . n_{L}
nᵢ^{S}Sᵢ<c_{S}P_{S}, for each i=1 . . . n_{S}

If any of the above constraints are not satisfied, the portfolio is rebalanced. The simulation records values of P from Start date to End date, and calculates their rolling variance using “MovingWindow” and “DaysPerYear.” The process is repeated as many times as given by the “Number of Simulations” input. The initial portfolio is randomly chosen and simulated from Start date to End date by readjusting the portfolio whenever necessary. Output statistics are realized volatility, average volatility, and standard deviation of volatility.

### Trading Methodology

Black-Scholes Options: A financial derivative is an instrument whose value is derived from an underlying asset. Black-Scholes options are one form of financial derivatives. Options are complex instruments that require sophisticated hedging schemes that allow a financial institution that provides these instruments to investors to manage the implicit risk. Among other risk management measures, these hedging schemes typically involve calculating the Delta of the option. The “Delta” is defined as the rate of change of the option price with respect to the price of the underlying asset; it is the slope of the curve that relates the option price to the underlying asset price, and signifies the amount of the underlying asset the Bank has to buy or sell to create a risk neutral (or Delta neutral) position with respect to the Option. The Delta of an option is a variable measure that changes over time as the value of the underlying asset changes. This means that the Bank's risk position remains Delta neutral for only a relatively short period of time. The hedge has to be adjusted periodically. This is known as rebalancing. If the hedging scheme was implemented continuously, the cost of hedging would, after discounting, be exactly equal to the theoretical price of the Option (that is, the premium for which the option is sold to investors).

Because funds typically provide only limited liquidity to buy into or redeem out of the fund (usually only on a monthly, quarterly, or even annual basis) it would be impossible for the Bank to continuously hedge its risk position. One aspect of the present invention comprises a technology solution that allows the Trading Desk to continuously assess its risk position based on the individual and aggregated portfolio data provided on the Funds via the prime brokerage account system. The Fund managers on the platform agree to daily, weekly, monthly or quarterly liquidity in the Fund units, allowing the Bank to adjust its hedge position in the underlying Funds at those intervals. If option Deltas deviate significantly from the Delta position established in Fund units on the relevant re-balancing dates, the Trading Desk can adjust its position by trading outside Fund in the underlying asset basket, either for a Fund individually or with respect to its overall portfolio of underlying Funds on the platform. On re-balancing dates the Trading Desk will cash settle its position in the underlying asset basket against Fund units by either: (a) selling a long position in the underlying asset basket and purchasing Fund units; or (b) covering a short position in the underlying asset basket with the cash received from a sale of Fund units. Stock borrow, if needed, is secured through prime brokerage account.

Periodic Reset Options: Another structured product sold to investors through the platform may be Periodic Reset Options (“PROs”) on Funds on the platform. These instruments rely on a reallocation mechanism between a risky asset—the Fund—and a fixed income asset so as to ensure a guaranteed amount at the end of the investment horizon. The basic strategy comprises increasing exposure to the risky asset as its value goes up, and decreasing exposure as its value goes down. The objective is to rebalance the portfolio in such a way as to always maintain the value of the overall portfolio above the present value of the guaranteed amount. Hence, at any point in time, the insured portfolio will be composed of investments in the risky asset and the riskless asset. Together, they constitute the Balanced Portfolio. In a preferred embodiment of the present invention, the risky asset is comprised of investments in a Fund on the platform, whereas the riskless asset is made up of liquid, cash-like instruments such as zero coupon bonds.

Another aspect of the present invention comprises a technology solution that allows the Trading Desk to continuously assess its risk position based on the individual Fund data provided on the Fund underlying the PRO via the prime brokerage account and implement the investment allocation mechanism. The Bank will also make up for any shortfall should the rebalancing mechanism fail to deliver the guaranteed amount at maturity. Such instances are more likely to occur when the underlying risky asset cannot be continuously traded or has poor liquidity, and is subject to potentially large jumps in value. Both of these elements are especially prevalent in typical fund investments. Effectively, the Bank provides insurance against the risk that there is a wide and sudden jump in the returns of the underlying Fund. The infrastructure and analytics of the present invention allow the Bank to better assess and manage that risk.

Other Structured Products: Other structured products sold to investors through the platform may be a combination of various building blocks to provide tailored pay-offs to investors. They may comprise either of the two products mentioned above in a levered or un-levered format. They may be full or partial principal protection. In general the infrastructure and analytics of preferred embodiments of the invention will allow the Bank to better price and risk manage any structured product on Funds on the platform sold to investors.

### Appendix—Sample Investment Guidelines

The following paragraphs A through D are the Investment Guidelines. Failure by the Manager to maintain the fund portfolio in accordance with the Investment Guidelines shall constitute a breach under these Investment Guidelines, as determined by the Calculation Agent in its sole discretion. Upon such breach, the Calculation Agent shall so notify the Manager. Failure of the Manager to correct such breach by 5:00 p.m. on the Calculation Day following the Notice Date shall constitute a default under the Investment Guidelines (an “Investment Guidelines Default”).

Those skilled in the art will recognize (based on the circumstances surrounding a particular Fund) preferred values and identities for those items identified below as dependent upon the underlying Fund.

A. Investment Universe

1. The fund portfolio may consist only of Permitted Investments.

2. All Securities must be listed for trading on a recognized, duly-authorized securities exchange, trading on which is denominated in one of the currencies set forth in paragraph 3 below, and, in the case of securities denominated in USD, on a U.S. Exchange. In the case of ADRs, both the ADR and the underlying common stock must satisfy this paragraph A.2

3. Up to [value depends on underlying Fund]% of the Fund NAV may be attributable to the total value of non-USD denominated Equity Securities in the fund portfolio, calculated as the sum of Long Market Values and Short Market Values for each non-USD denominated Equity Security converted at prevailing USD spot rates.

4. No Equity Security may be a “restricted security” as that term is defined in Rule 144 of the U.S. Securities Act of 1933, as amended.

B. Concentration Limitations

1. Each of the Long Market Value and the Short Market Value for a single issuer, excluding any issuers that are Qualified Exchange Traded Funds may account for no more than [value depends on underlying Fund]% of the Fund NAV. For the purposes of this calculation, the issuer of shares of common stock and the issuer of an ADR related to such shares shall be deemed to be the same single issuer.

2. Each of the Long Market Value and the Short Market Value for any one Industry Sector may account for no more than [value depends on underlying Fund]% of the Fund NAV.

3. As of 5 p.m. (New York time) on any Calculation Day, neither the Long Market Value nor the Short Market Value for a single issuer shall comprise more than [value depends on underlying Fund] day's trading volume, as calculated by the average of the previous thirty days' daily trading volume for such issuer on its primary trading exchange, as published by Bloomberg.

C. Leverage Guidelines

1. The Fund's Leverage Ratio may be adjusted as a result of an Upward Volatility Event.

An Upward Volatility Event will be deemed to occur if, on any Calculation Day, the Calculation Agent determines, in its sole discretion, that the Period Volatility exceeds the Volatility Cap. If an Upward Volatility Event occurs, the Fund's maximum Leverage Ratio shall be reset for the duration of the Deleveraging Period to equal [value depends on underlying Fund] multiplied by the average Leverage Ratio for the [value depends on underlying Fund] consecutive Calculation Days leading up to but excluding the date of the Upward Volatility Event. However, if on the [value depends on underlying Fund]th Calculation Day of such Deleveraging Period, the Calculation Agent determines, in its sole discretion, that the Period Volatility exceeds the Volatility Cap, another Upward Volatility Event will be deemed to occur and the Fund's maximum Leverage Ratio shall be further reduced for the duration of the Deleveraging Period to equal [value depends on underlying Fund] multiplied by the previously prevailing maximum Leverage Ratio. If on the first Calculation Day after the final day of the Deleveraging Period, the Period Volatility is below the Volatility Cap, the Fund's Leverage Ratio may be reset to levels permitted before the Upward Volatility Event occurred.

No Upward Volatility Event will be deemed to occur for the first [value depends on underlying Fund] Calculation Days following the Funding Date.

Definitions:

Administrator means [identity depends on underlying Fund]

Calculation Agent means Bank. All calculations and determinations made by the Calculation Agent shall be made in its sole discretion.

Calculation Day means any Exchange Business Day on which the Calculation Agent calculates the Adjusted Period Volatility.

Cash means USD and US Treasury bills.

Deleveraging Period means the period from and including the Calculation Day following an Upward Volatility Event, to the earliest to occur of (i) an Upward Volatility Event or (ii) the [value depends on underlying Fund]th Calculation Day following such Upward Volatility Event.

Delta Value means an amount, to be determined by the Calculation Agent in its sole discretion, equal to the product of (i) the number of shares necessary to hold short (in the case of Bullish Option positions) or long (in the case of Bearish Option positions) in order for a holder of a Permitted Option to hedge its equity price risk under such option, multiplied by (ii) the price per share of such shares as of 5 p.m. on any Calculation Day.

Exchange Business Day means any day on which a U.S. Exchange or U.S. Options Exchange on which any Securities or options thereon in the fund portfolio are traded is open for trading during its regular trading sessions.

Fund means [identity depends on underlying Fund].

Fund NAV means the total assets of the Fund minus the total liabilities of the Fund, as determined by the Administrator.

Funding Date means the effective date of the Member's initial subscription for Units of the Fund.

Industry Sector means any of the ten (10) “Bloomberg Level 1 Economic Sectors” as published on Bloomberg page EQUITY TKI.

Leverage Ratio means the greater of the Long Market Value of the fund portfolio or the Short Market Value of the fund portfolio divided by the Fund NAV.

Long Market Value means, with respect to a single issuer, a single Sector or Qualified Exchange Traded Fund, as applicable, the greater of zero or the mark-to-market value of all long positions in Securities (or Qualified Exchange Traded Fund as applicable) plus the notional value of purchased call options and written put options minus the mark to market value of all open short positions Securities (or Qualified Exchange Traded Fund as applicable) minus the Delta Value of written call options and purchased put options.

Long Market Value of the fund portfolio means the sum of all Long Market Values for all single issuers and Qualified Exchange Traded Funds.

Manager means [identity depends on underlying Fund]

Member means Bank.

Notice Time means 12:00 p.m. (New York time) on the Calculation Day immediately following the day upon which the breach that is the subject of such notice occurs

Notice Date means, if notice of breach is delivered prior to the Notice Time, such day, and if notice is delivered after the notice time, the next following Calculation Day after the day upon which such notice is delivered.

Per Unit Value means the value per unit of the Fund, as determined by the Administrator, except that for purposes of calculating Average Realized Volatility, the Per Unit Value shall be determined by the Calculation Agent.

Period Volatility: On any Calculation Day beginning on the [value depends on underlying Fund]^{st} Calculation Day following the Funding Date, average daily annualized volatility during the Sampling Period, calculated by the Calculation Agent according to the following formula:

$$\sqrt{\frac{N}{n - 1} \cdot {\sum }_{i = 1}^{n} {[ Ri - \overline{R} ]}^{2}}$$

where Rᵢ means

$$ln ( \frac{{S}_{i}}{{S}_{i - 1}} )$$

\overline{R}means

$$\frac{1}{n} \cdot {\sum }_{i = 1}^{n} {R}_{i}$$

Sᵢ means the Per Unit Value on the (n - i)th previous Exchange Business Day before day (t)

n is equal to [value depends on underlying Fund]

N is equal to 260

Permitted Investments means Securities, Qualified Exchange Traded Funds, Permitted Options, and Cash.

Permitted Option means any option contract (i) that is listed on a U.S. Options Exchange, and (ii) in respect of which, if the number of shares of the security underlying the option contract were actually held by the Fund, such position would be within the Investment Universe, as described above.

Qualified Exchange Traded Fund means [identity depends on underlying Fund]

Sample Observation Date means each Exchange Business Day during the Sampling Period.

Sampling Period means the [value depends on underlying Fund] Calculation Days immediately preceding and including the relevant Calculation Day.

Security means [identity depends on underlying Fund].

Short Market Value means, with respect to a single issuer, a single Sector, or Qualified Exchange Traded Fund, as applicable, the greater of zero or the mark-to-market value of all open short positions in Equity Securities (or Qualified Exchange Traded Fund as applicable) plus the notional value of written call options and purchased put options minus the mark to market value of all long Equity Securities (or Qualified Exchange Traded Fund as applicable) minus the Delta Value of purchased call options and written put options.

Short Market Value of the fund portfolio means the sum of all Short Market Values for all single issuers and Qualified Exchange Traded Funds.

U.S. Exchange means an exchange (as defined in Section 3(a)(1) of the Securities Exchange Act of 1934, as amended (the “Exchange Act”)) that is registered as a national securities exchange under Section 6 of the Exchange Act, and the NASDAQ National Market System.

U.S. Options Exchange means a U.S. Exchange on which options contracts on Equity Securities are traded.

Volatility Cap means [value depends on underlying Fund]%.

What is claimed is:

1. A computer system for providing an infrastructure platform, comprising:
a bank computer operable to communicate via a computer network with a fund manager computer operated by a fund manager managing a fund,
wherein said bank computer is operated by a bank holding a security interest over one or more assets of said fund, said bank having agreed with said fund manager to one or more investment guidelines regarding said fund,
wherein said one or more investment guidelines constrain said fund manager to trade said one or more assets in a specified manner, and
wherein said fund underlies a structured product sold to one or more investors.

2. A system as in claim 1, wherein said structured product comprises at least one of: (a) a Black-Scholes option; (b) a periodic reset option; and (c) another structured product.

3. A system as in claim 1, further comprising a securities trading desk computer in communication with said bank computer and operable to monitor said fund's compliance with said one or more investment guidelines.

4. A system as in claim 1, further comprising a securities trading desk computer in communication with said bank computer and operable to monitor said fund's net asset value.

5. A system as in claim 4, wherein said securities trading desk computer is further operable to calculate a realized volatility of said fund's returns on a daily basis.

6. A system as in claim 1, wherein said system is operable to price said structured product based on a historical volatility calculation.

7. A system as in claim 6, wherein said historical volatility calculation is based on a software-implemented simulation model that estimates historical realized volatility of one or more portfolios based on one or more investment constraints defined in said one or more investment guidelines.

8. A system as in claim 7, wherein one or more of said one or more investment constraints relate to at least one of: a long portion and a short portion of one or more portfolios.

9. A system as in claim 3, wherein said trading desk computer is further operable to adjust a position in said fund by trading outside said fund in an underlying asset basket.

10. A system as in claim 9, wherein said position is adjusted based on deviation of an option delta.

11. A system as in claim 10, wherein said option comprises a Black-Scholes option.

12. A system as in claim 3, wherein said structured volatility trading desk computer is further operable to continuously assess a risk position based on fund data received from a prime brokerage account computer.

13. A computer system for providing an infrastructure platform, comprising:
a fund manager computer operated by a fund manager managing a fund; and
a bank computer in communication with said fund manager computer via a computer network,
wherein said bank computer is operated by a bank holding a security interest over one or more assets of said fund, said bank having agreed with said fund manager to one or more investment guidelines regarding said fund;
wherein said one or more investment guidelines constrain said fund manager to trade said one or more assets in a specified manner; and
wherein said fund underlies a structured product sold to one or more investors.
